(19) United States
(12) Patent Application Publication
(10) Pub. No.: US 2018/0367057 A1
(43) Pub. Date: Dec. 20, 2018

(54) Electrical Power Conversion and Distribution Device

(71) Applicants: Robert William Calicchio, Riverside, CA (US); Yukio Nakadate, Las Vegas, NV (US); Elbert Kim, Anaheim, CA (US)

(72) Inventors: Robert William Calicchio, Riverside, CA (US); Yukio Nakadate, Las Vegas, NV (US); Elbert Kim, Anaheim, CA (US)

(21) Appl. No.: 16/013,900

(22) Filed: Jun. 20, 2018

Related U.S. Application Data
(60) Provisional application No. 62/522,390, filed on Jun. 20, 2017.

(51) Int. Cl. H02M 7/162; H01H 71/10; H05B 37/02

(52) U.S. Cl. CPC H02M 7/1626; H05B 37/0209; H01H 71/1045

(57) ABSTRACT

An electrical power conversion and distribution device consists of a power input terminal, a user control unit, an AC/DC converter, and a plurality of circuit breakers. The power input terminal is electrically connected to the AC/DC converter, and transmits AC received from an external power supply to the AC/DC converter. The AC/DC converter is configured to convert the AC received through the power input terminal into DC and output the DC to the plurality of circuit breakers. A variety of electrical appliances may be connected to the circuit breakers and operated by the DC output. 120 volt AC may be converted into 24 volt DC for energy savings in applications such as lighting.

The current application claims a priority to the U.S. Provisional Patent application Ser. No. 62/522,390 filed on Jun. 20, 2017.

### FIELD OF THE INVENTION

The present invention relates generally to electrical power distribution. More particularly, the present invention relates to an AC to DC converter for low-voltage applications.

### BACKGROUND OF THE INVENTION

Power supplies for traditional lighting systems are highly inefficient. These devices are designed to work with traditional light bulbs which require large amounts of electrical power. Additionally, traditional power supplies for lighting systems do not adequately protect the lighting systems from electrical current overloads.

The present invention, an electrical power conversion and distribution device, addresses these shortcomings by using an AC/DC converter to supply electrical power to energy efficient lighting systems. Additionally, the present invention makes use of a circuit breaker system to prevent damage due to overcurrent situations. Preferably the present invention powers a straight 24V DC LED lighting system that uses LED Light Bulbs which have no transformers. Straight 24V DC Powered LED light bulbs without transformers pose no threat of electrocution, use less electricity, have a much longer life span, and generate a lot less heat. Using the present invention with a straight 24V DC LED lighting system reduces the power consumption by 80% to 90%.

### BRIEF DESCRIPTION OF THE DRAWINGS

FIG. 1 is a general diagram of the components of the present invention.

FIG. 2 is an electronic circuit diagram of various electrical components of the present invention.

FIG. 3 is an illustration of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

The present invention is an electrical power conversion and distribution device. More particularly, the present invention is a power supply system that converts alternating current (AC) power to direct current (DC) power and delivers the DC power to at least one connected electrical load. Additionally, the present invention makes use of a circuit breaking system that protects the connected electrical load from being damaged by a current overload. The present invention is preferably a power supply used to distribute electrical power to a multicomponent lighting system.

The present invention may facilitate several benefits to the user, such as, but not limited to, substantial electricity usage reduction compared to standard 120 volt AC lighting (up to 95% reduction in various embodiments), minimal or no heat generation, and usability in and around water with no risk of electrocution.

The present invention was primarily designed for use in lighting applications that are either in or near water, but may be used for any relevant needs. The present invention was furthermore designed mainly with straight 24 volt DC LED lighting in mind, or other types of lighting, such as, but not limited to: swimming pool lights, jacuzzi/spa lighting, fountain lighting, fish pond lighting, landscape lighting, outdoor security lights, or any other applicable type of lighting or electrical application that is capable of making use of the present invention. The preferred embodiment of the present invention is suitable for indoor or outdoor use, and may be compatible with wind, hydro and solar electrical generation.

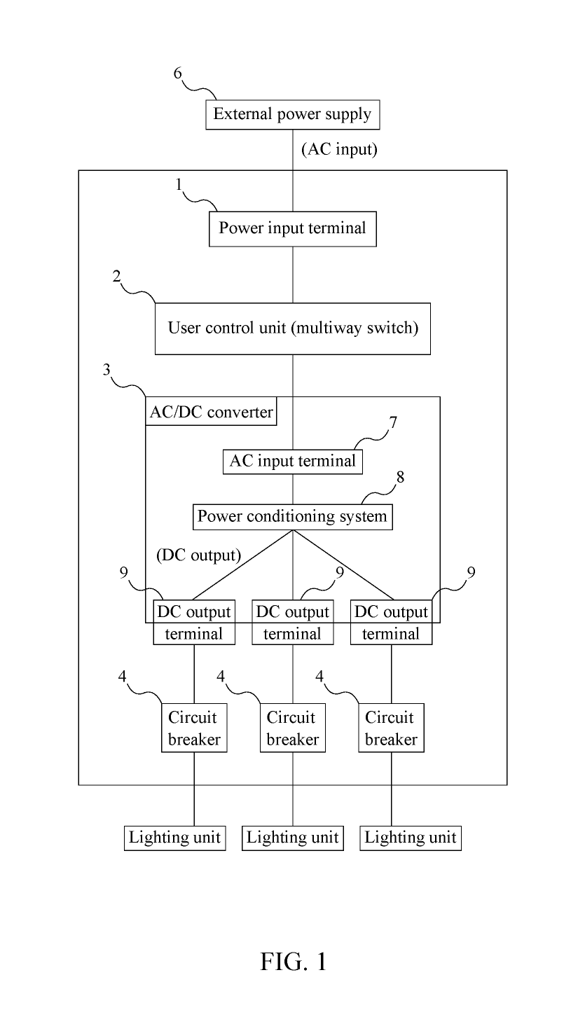

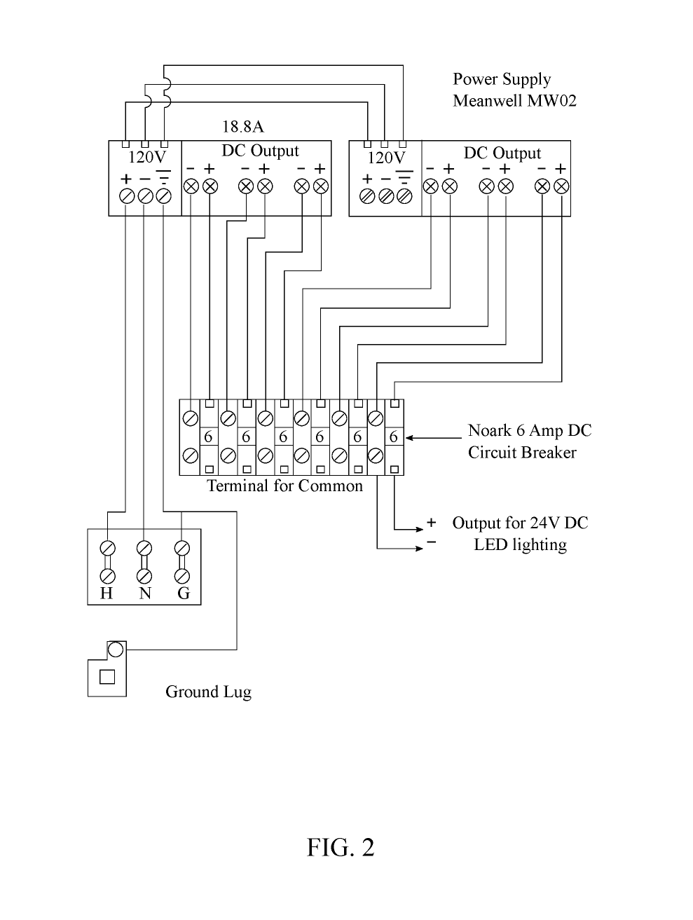

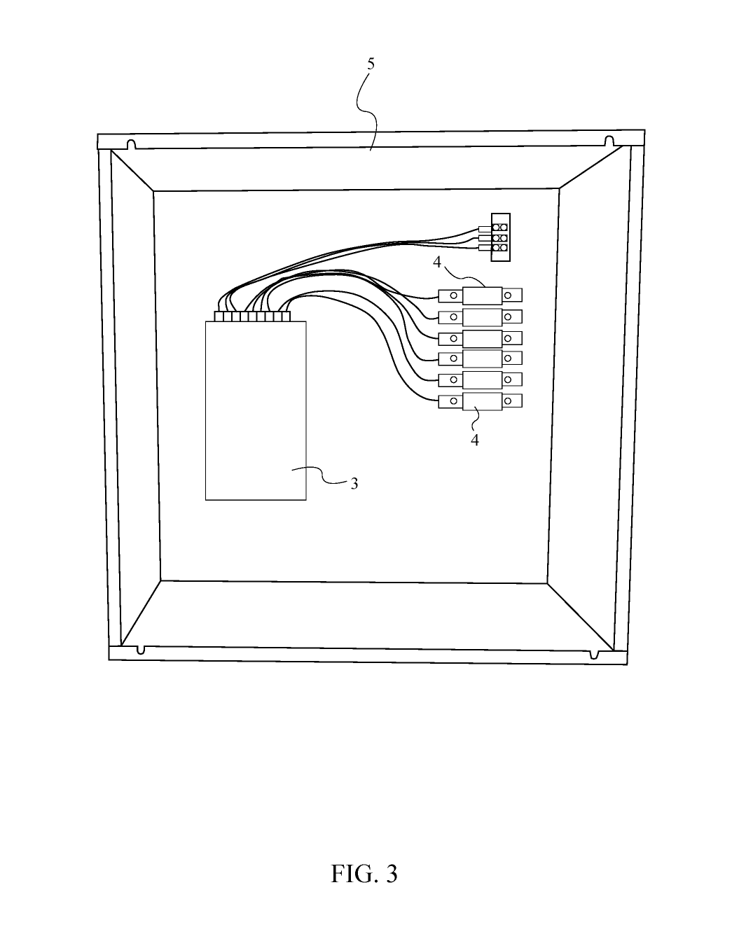

Referring to FIGS. 1-3, in general, the preferred embodiment of the present invention comprises a power input terminal 1, a user control unit 2, an AC/DC converter 3, and a plurality of circuit breakers 4. Furthermore, in the preferred embodiment, the present invention further comprises a casing 5, within which the user control unit 2, the at least one AC/DC converter 3, and the plurality of circuit breakers 4 are housed. The casing 5 is a rigid enclosure housing the remaining components of the present invention, and is preferably waterproof.

In the preferred embodiment, the power input terminal 1 is an electrical connector that is used to electrically connect the present invention to an external power supply 6, and is configured to receive AC power from the external power supply 6. The power input terminal 1 connects the present invention to the external power supply 6 and provides the AC power that is fed to the AC/DC converter 3. In some embodiments, the AC power received by the power input terminal 1 may be 120 volt AC which is standard for general-purpose appliances across North America. In other embodiments, the AC power received from the external power supply 6 may have different characteristics. The power input terminal 1 is electrically connected to the AC/DC converter 3 through the user control unit 2. Alternatively stated, the power input terminal 1 is electrically connected to the user control unit 2, and the user control unit 2 is further electrically connected to the AC/DC converter 3.

Preferably, the user control unit 2 is an intermediary switching system that is electrically connected in between the power input terminal 1 and the AC/DC converter 3. The present invention is designed to enable the user to select the type of electrical power that is delivered to the AC/DC converter 3 using the user control unit 2. For example, the user is able to select whether the AC power delivered to the AC/DC converter 3 is 120V or 240V. To accomplish this, in the preferred embodiment, the user control unit 2 is a multiway switching unit. The user control unit 2 acts as a switch that enables the user to set the maximum voltage that will be delivered to the AC/DC converter 3.

The AC/DC converter 3 is preferably a single input-multiple output power distributor that is electrically connected to the plurality of circuit breakers 4. As a result, the AC power that is provided by the power supply is converted into DC power through the AC/DC converter 3, and then supplied to the connected electrical load through the plurality of circuit breakers 4.

The AC/DC converter 3 is preferably used to supply DC power to the plurality of circuit breakers 4. To accomplish this, the AC/DC converter 3 comprises an AC input terminal 7, a power conditioning system 8, and a plurality of DC output terminals 9. The AC input terminal 7 is an electrical terminal that is electrically connected to the power input terminal 1 through the user control unit 2. AC power is delivered to the AC/DC converter 3 through the AC input terminal 7. Since the AC input terminal 7 is electrically connected to the power conditioning system 8, the AC power is then supplied to the power conditioning system 8. The power conditioning system 8 is an electrical component used to convert the supplied AC power into regulated DC power. The power conditioning system 8 is electrically connected to the plurality of DC output terminals 9.

The AC/DC converter 3 is configured in the preferred embodiment to convert AC received through the power input terminal 1 into DC and output the DC to the plurality of circuit breakers 4. More specifically, in the preferred embodiment, the AC/DC converter 3 is configured to convert 120 volt AC received through the power input terminal 1 into 24 volt DC outputted to each of the plurality of circuit breakers 4.

The power conditioning system 8 is configured to convert AC received by the power conditioning system 8 through the AC input terminal 7 into DC and output the DC to the plurality of DC input terminals. Furthermore, each of the plurality of DC output terminals 9 is electrically connected to one of the plurality of circuit breakers 4. The plurality of DC output terminals 9 is a collection of electrical connectors that supply the DC power to the plurality of circuit breakers 4. Specifically, each of the plurality of DC output terminals 9 is electrically connected to a corresponding circuit breaker from the plurality of circuit breakers 4. Thus connected, the plurality of circuit breakers 4 functions as current limiting switches that open the circuit between the AC/DC converter 3 and the connected electrical load if the current exceeds a predetermined threshold. In the preferred embodiment, each of the plurality of circuit breakers 4 is rated for 6 amps, though in various other embodiments each of the plurality of circuit breakers 4 may have different specifications.

Although the invention has been explained in relation to its preferred embodiment, it is to be understood that many other possible modifications and variations can be made without departing from the spirit and scope of the invention as hereinafter claimed.

What is claimed is:

1. An electrical power conversion and distribution device comprises:
a power input terminal;
a user control unit;
an alternating current (AC)/direct current (DC) converter;
a plurality of circuit breakers;
the power input terminal being configured to receive AC from an external power supply;
the power input terminal being electrically connected to the AC/DC converter through the user control unit; and
the AC/DC converter being electrically connected to the plurality of circuit breakers, wherein the AC/DC converter is configured to convert AC received through the power input terminal into DC and output the DC to the plurality of circuit breakers.

2. The electrical power conversion and distribution device as claimed in claim 1 comprises:
the AC/DC converter being configured to convert 120 volt AC into 24 volt DC.

3. The electrical power conversion and distribution device as claimed in claim 1 comprises:
the user control unit being a multiway switching unit.

4. The electrical power conversion and distribution device as claimed in claim 1 comprises:
the AC/DC converter comprises an AC input terminal, a power conditioning system, and a plurality of DC output terminals;
the power input terminal being electrically connected to the AC input terminal through the user control unit;
the AC input terminal being electrically connected to the power conditioning system;
the power conditioning system being electrically connected to the plurality of DC output terminals;
the power conditioning system being configured to convert AC received through the AC input terminal into DC and output the DC to the plurality of DC output terminals; and
each of the plurality of DC output terminals being electrically connected to one of the plurality of circuit breakers.

5. The electrical power conversion and distribution device as claimed in claim 1 comprises:
each of the plurality of circuit breakers being rated for 6 amps.

6. An electrical power conversion and distribution device comprises:
a power input terminal;
a user control unit;
an alternating current (AC)/direct current (DC) converter;
a plurality of circuit breakers;
the power input terminal being configured to receive AC from an external power supply;
the power input terminal being electrically connected to the AC/DC converter through the user control unit;
the AC/DC converter being electrically connected to the plurality of circuit breakers, wherein the AC/DC converter is configured to convert AC received through the power input terminal into DC and output the DC to the plurality of circuit breakers;
the AC/DC converter being configured to convert 120 volt AC into 24 volt DC; and
the user control unit being a multiway switching unit.

7. The electrical power conversion and distribution device as claimed in claim 6 comprises:
the AC/DC converter comprises an AC input terminal, a power conditioning system, and a plurality of DC output terminals;
the power input terminal being electrically connected to the AC input terminal through the user control unit;
the AC input terminal being electrically connected to the power conditioning system;
the power conditioning system being electrically connected to the plurality of DC output terminals;
the power conditioning system being configured to convert AC received through the AC input terminal into DC and output the DC to the plurality of DC output terminals; and
each of the plurality of DC output terminals being electrically connected to one of the plurality of circuit breakers.

8. The electrical power conversion and distribution device as claimed in claim 6 comprises:
each of the plurality of circuit breakers being rated for 6 amps.

9. An electrical power conversion and distribution device comprises:
a power input terminal;
a user control unit;
an alternating current (AC)/direct current (DC) converter;
a plurality of circuit breakers;
the power input terminal being configured to receive AC from an external power supply;
the power input terminal being electrically connected to the AC/DC converter through the user control unit;
the AC/DC converter being electrically connected to the plurality of circuit breakers, wherein the AC/DC converter is configured to convert AC received through the power input terminal into DC and output the DC to the plurality of circuit breakers;
the AC/DC converter comprises an AC input terminal, a power conditioning system, and a plurality of DC output terminals;
the power input terminal being electrically connected to the AC input terminal through the user control unit;
the AC input terminal being electrically connected to the power conditioning system;
the power conditioning system being electrically connected to the plurality of DC output terminals;
the power conditioning system being configured to convert AC received through the AC input terminal into DC and output the DC to the plurality of DC output terminals; and
each of the plurality of DC output terminals being electrically connected to one of the plurality of circuit breakers.

10. The electrical power conversion and distribution device as claimed in claim 1 comprises:
the AC/DC converter being configured to convert 120 volt AC into 24 volt DC.

11. The electrical power conversion and distribution device as claimed in claim 1 comprises:
the user control unit being a multiway switching unit.

12. The electrical power conversion and distribution device as claimed in claim 1 comprises:
each of the plurality of circuit breakers being rated for 6 amps.
